(19) United States
(12) Patent Application Publication
(10) Pub. No.: US 2022/0404078 A1
(43) Pub. Date: Dec. 22, 2022

(54) Gas-Liquid Separation Device and Refrigeration Cycle Apparatus

(71) Applicant: Mitsubishi Electric Corporation, Tokyo (JP)

(72) Inventors: Tetsuhide YOKOYAMA, Tokyo (JP); Hiroki ISHIYAMA, Tokyo (JP); Yusuke TASHIRO, Tokyo (JP); Hirofumi MATSUDA, Tokyo (JP); Shun KATO, Tokyo (JP)

(21) Appl. No.: 17/779,269

(22) PCT Filed: Dec. 27, 2019
(86) PCT No.: PCT/JP2019/051538

§ 371 Date: May 24, 2022

(51) Int. Cl. F25B 43/04; B04C 3/06

(52) U.S. Cl. CPC F25B 43/043; B04C 3/06; F25B 2400/23; B04C 2003/006

(57) ABSTRACT

A gas-liquid separation device comprises a container, an inlet tube, a liquid outlet tube, a gas outlet tube, and a swirl vane. The swirl vane is disposed in the inlet tube. A depression is provided on an inner circumferential surface of the inlet tube. The depression faces the swirl vane.

### CROSS-REFERENCE TO RELATED APPLICATION

This application is a U.S. National Stage Application of International Application No. PCT/JP2019/051538 filed on Dec. 27, 2019 the contents of which are incorporated herein by reference.

### TECHNICAL FIELD

The present invention relates to a gas-liquid separation device and a refrigeration cycle apparatus.

### BACKGROUND

Conventionally, a compressor used as a driving source for typical air conditioners, refrigeration apparatuses and the like discharges oil that lubricates an interior of the compressor to outside the compressor together with compressed high-pressure refrigerant gas. As a result, the compressor runs out of oil and may have a sliding portion thereof seized. Accordingly, an oil separator is used to separate oil from an oil-containing refrigerant discharged from the compressor and return the oil to the compressor. The oil separator separates gaseous refrigerant and liquid oil. That is, a gas-liquid two-phase stream having gas and liquid mixed together is separated into gas and liquid.

A gas-liquid separation device that separates a gas-liquid two-phase stream into gas and liquid is not only applied to an oil separator but is also applied to various devices. For example, Japanese Patent Application Laying-Open No. 2002-324561 (PTL 1) discloses a gas-liquid separation device that separates water from exhaust hydrogen gas and exhaust air used for a reaction in a body of a fuel cell. In this gas-liquid separation device, a shaft is disposed inside a receiving duct, and a plurality of helical swirl vanes are provided circumferentially of the shaft on a circumferential surface of the shaft. The plurality of helical swirl vanes produce a swirling stream. The swirling stream centrifugally separates gas and liquid.

### PATENT LITERATURE

PTL 1: Japanese Patent Laid-Open No. 2002-324561

The gas-liquid separation device disclosed in the above publication causes a swirling stream, which causes centrifugal force and thereby moves liquid toward an inner circumferential surface of the receiving duct. When the receiving duct has a larger inner circumferential surface, the receiving duct has a larger area to which liquid adheres, and the gas-liquid separation device can separate gas and liquid more efficiently. However, when the receiving duct has a larger inner circumferential surface, the receiving duct will have a larger size. Accordingly, the gas-liquid separation device has a larger size.

### SUMMARY

The present invention has been made in view of the above problem, and an object of the present invention is to provide a gas-liquid separation device that can improve efficiency of separating gas and liquid and also be miniaturized.

The gas-liquid separation device of the present invention separates a gas-liquid two-phase fluid into a gas and a liquid. The gas-liquid separation device comprises a container, an inlet tube, a liquid outlet tube, a gas outlet tube, and a swirl vane. The container extends in a top-to-bottom direction. The inlet tube extends along a central axis in the top-to-bottom direction and has an inner surface surrounding the central axis, an inlet port configured to allow the gas-liquid two-phase fluid to flow into the gas-liquid separation device, and an outlet port configured to allow the gas-liquid two-phase fluid to flow into the container. The liquid outlet tube has a liquid outlet port configured to allow the liquid separated from the gas-liquid two-phase fluid to be discharged from the container. The gas outlet tube has a gas outlet port configured to allow the gas separated from the gas-liquid two-phase fluid to be discharged from the container. The swirl vane is disposed in the inlet tube. The inlet port of the inlet tube is located above the swirl vane. The outlet port of the inlet tube is located below the swirl vane. The liquid outlet port of the liquid outlet tube is located below the swirl vane. The gas outlet port of the gas outlet tube is located below the swirl vane and above the liquid outlet port. The inner surface of the inlet tube has a depression. The depression faces the swirl vane.

In the gas-liquid separation device of the present invention, an inlet tube has an inner circumferential surface provided with a depression, and the depression faces a swirl vane. The depression can increase an area to which liquid adheres, and also prevent the inlet tube from having an increased size. This can improve efficiency of separating gas and liquid and also allows the gas-liquid separation device to be miniaturized.

### BRIEF DESCRIPTION OF DRAWINGS

FIG. 1 is a refrigerant circuit diagram of a refrigeration cycle apparatus comprising a gas-liquid separation device according to a first embodiment.

FIG. 2 is a schematic cross section of a configuration of the gas-liquid separation device according to the first embodiment.

FIG. 3 is a cross section taken along a line III-III indicated in FIG. 2.

FIG. 4 is a cross section taken along a line IV-IV indicated in FIG. 2.

FIG. 5 is a schematic perspective view of a configuration of a swirl vane of the gas-liquid separation device according to the first embodiment of the present invention.

FIG. 6 is a schematic cross section of a configuration of a gas-liquid separation device according to a second embodiment.

FIG. 7 is a cross section taken along a line VII-VII indicated in FIG. 6.

FIG. 8 is a schematic perspective view of a configuration with a swirl vane according to the second embodiment disposed in an inlet tube.

FIG. 9 is a cross section taken along a line IX-IX indicated in FIG. 8.

FIG. 10 is a schematic cross section of a configuration of a tubular portion of a first exemplary variation of the gas-liquid separation device according to the second embodiment.

FIG. 11 is a schematic cross section of the configuration of the tubular portion of the first exemplary variation of the gas-liquid separation device according to the second embodiment.

FIG. 12 is a schematic cross section of a configuration of a tubular portion of a second exemplary variation of the gas-liquid separation device according to the second embodiment.

FIG. 13 is a cross section taken along a line XIII-XIII indicated in FIG. 12.

FIG. 14 is a schematic cross section of a configuration of a gas-liquid separation device according to a third embodiment.

FIG. 15 is a schematic cross section of a configuration of a gas-liquid separation device according to a fourth embodiment.

FIG. 16 is a cross section taken along a line XVI-XVI indicated in FIG. 15.

FIG. 17 is a schematic perspective view of a configuration with a swirl vane according to the fourth embodiment disposed in the inlet tube.

FIG. 18 is a cross section taken along a line XVIII-XVIII indicated in FIG. 17.

### DETAILED DESCRIPTION

Hereinafter, embodiments of the present invention will be described with reference to the drawings. In the following, identical or equivalent members and parts are identically denoted and will not be described redundantly.

### First Embodiment

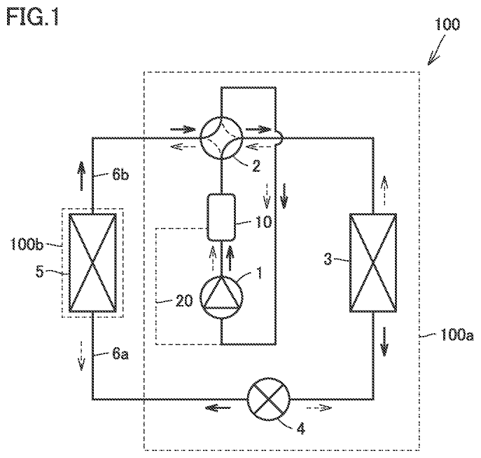

Initially, a configuration of a refrigeration cycle apparatus 100 according to a first embodiment of the present invention will be described with reference to FIG. 1. FIG. 1 is a refrigerant circuit diagram of refrigeration cycle apparatus 100 according to the present embodiment. Refrigeration cycle apparatus 100 in the present embodiment is, for example, an air conditioner using a vapor compression refrigeration cycle in which refrigerant is compressed by a compressor. As an example of a gas-liquid separation device 10, an oil separator that separates oil from high-pressure gas refrigerant increased in pressured by a compressor will be described.

As shown in FIG. 1, refrigeration cycle apparatus 100 according to the present embodiment mainly comprises a compressor 1, a four-way valve 2, an outdoor heat exchanger 3, a flow rate regulating valve 4, an indoor heat exchanger 5, and gas-liquid separation device (an oil separator) 10. Compressor 1, four-way valve 2, outdoor heat exchanger 3, flow rate regulating valve 4, indoor heat exchanger 5, and gas-liquid separation device 10 are connected by a pipe. Refrigeration cycle apparatus 100 has a refrigerant circuit thus configured. Compressor 1, four-way valve 2, outdoor heat exchanger 3, flow rate regulating valve 4, and gas-liquid separation device 10 are disposed in an outdoor unit 100a. Indoor heat exchanger 5 is disposed in an indoor unit 100b. Outdoor unit 100a and indoor unit 100b are connected by extension pipes 6a and 6b.

Compressor 1 is configured to suck, compress and discharge refrigerant. Compressor 1 is configured to suck low-pressure gas refrigerant from outdoor heat exchanger 3 (in a heating operation) or indoor heat exchanger 5 (in a cooling operation), compress the low-pressure gas refrigerant, and thus discharge high-pressure gas refrigerant. Compressor 1 may be a fixed displacement compressor having a fixed compression capacity or an inverter compressor having a variable compression capacity. The inverter compressor is configured to be controllable in rotational speed variably.

Four-way valve 2 is configured to switch flow of refrigerant. Specifically, four-way valve 2 is configured to switch flow of refrigerant so that refrigerant discharged from compressor 1 is passed to outdoor heat exchanger 3 (in the cooling operation) or indoor heat exchanger 5 (in the heating operation).

Outdoor heat exchanger 3 is connected to four-way valve 2 and flow rate regulating valve 4. Outdoor heat exchanger 3 in the cooling operation serves as a condenser configured to condense refrigerant compressed by compressor 1. Outdoor heat exchanger 3 in the heating operation serves as an evaporator configured to evaporate refrigerant reduced in pressure by flow rate regulating valve 4. Outdoor heat exchanger 3 is provided to exchange heat between refrigerant and air. Outdoor heat exchanger 3 comprises, for example, a pipe (a heat transfer tube) passing refrigerant therethrough, and fins attached to an external side of the pipe.

Flow rate regulating valve 4 is connected to outdoor heat exchanger 3 and indoor heat exchanger 5. Flow rate regulating valve 4 in the cooling operation serves as a throttle device configured to reduce pressure of refrigerant condensed by outdoor heat exchanger 3. Flow rate regulating valve 4 in the heating operation serves as a throttle device configured to reduce pressure of refrigerant condensed by indoor heat exchanger 5. Flow rate regulating valve 4 is, for example, a capillary tube, an electronic expansion valve, or the like.

Indoor heat exchanger 5 is connected to four-way valve 2 and flow rate regulating valve 4. Indoor heat exchanger 5 in the cooling operation serves as an evaporator configured to evaporate refrigerant reduced in pressure by flow rate regulating valve 4. Indoor heat exchanger 5 in the heating operation serves as a condenser configured to condense refrigerant compressed by compressor 1. Indoor heat exchanger 5 is provided to exchange heat between refrigerant and air. Indoor heat exchanger 5 comprises, for example, a pipe (a heat transfer tube) passing refrigerant therethrough, and fins attached to an external side of the pipe.

Gas-liquid separation device (or oil separator) 10 is connected downstream of a discharge pipe of compressor 1. Gas-liquid separation device 10 is configured to separate gas-liquid two-phase fluid into a gas (gas refrigerant) and a liquid (oil). In the present embodiment, gas-liquid separation device (or oil separator) 10 is configured to separate oil from oil-containing refrigerant discharged from compressor 1. Further, an oil returning pipe 20 is connected to gas-liquid separation device (or oil separator) 10 to return the oil separated from the oil-containing refrigerant to a side upstream of a suction pipe of compressor 1.

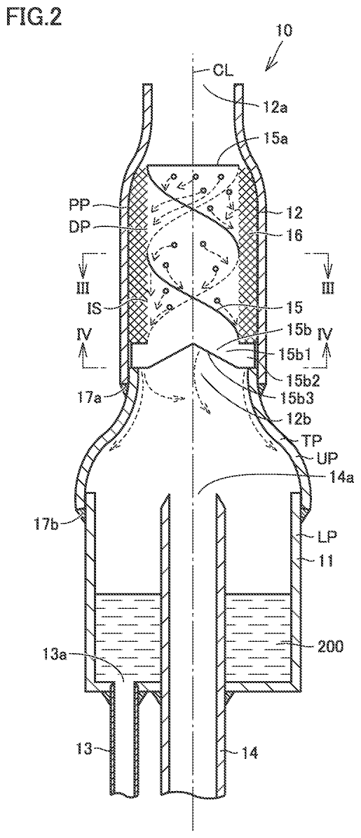

Reference will now be made to FIGS. 2 to 5 to specifically describe the configuration of gas-liquid separation device 10 according to the present embodiment.

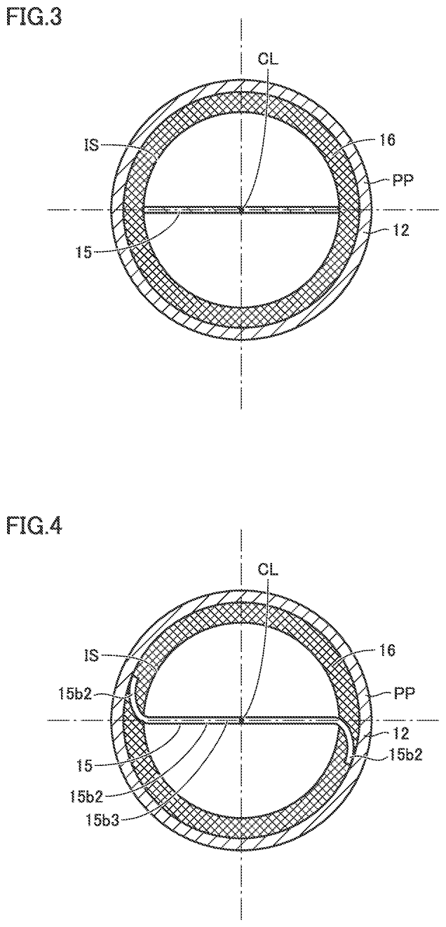

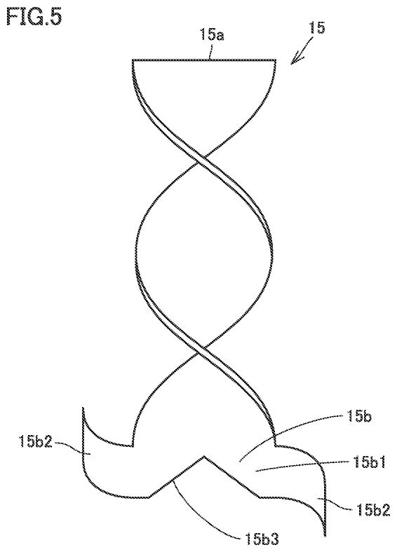

FIG. 2 is a schematic cross section of the configuration of gas-liquid separation device 10 according to the present embodiment. FIG. 3 is a cross section taken along a line III-III indicated in FIG. 2. FIG. 4 is a cross section taken along a line IV-IV indicated in FIG. 2. FIG. 5 is a schematic perspective view of a configuration of swirl vane 15 of the gas-liquid separation device according to the present embodiment.

As shown in FIG. 2, gas-liquid separation device 10 according to the present embodiment comprises a container 11, an inlet tube 12, a liquid outlet tube 13, a gas outlet tube 14, and swirl vane 15. A separation system using a swirling downward stream is applied to gas-liquid separation device 10 according to the present embodiment.

Container 11 extends in a vertical direction. Container 11 has an internal space. Container 11 has an internal wall surface surrounding the internal space. The internal wall surface of container 11 is configured to be round in a cross section orthogonal to the vertical direction. Container 11 has an oil reserving volume of an extent such that container 11 is not emptied or does not have oil spilled by variation in load.

Container 11 includes an upper portion UP and a lower portion LP. Upper portion UP has an upper end connected to inlet tube 12. The upper end of upper portion UP and inlet tube 12 are fixed together by a weld 17a. Upper portion UP has a lower end connected to lower portion LP. The lower end of upper portion UP and lower portion LP are fixed together by a weld 17b.

Container 11 includes a tapered portion TP connected to inlet tube 12. Tapered portion TP is provided at upper portion UP. Tapered portion TP is inclined to have a smaller inner diameter toward inlet tube 12. The inner diameter of tapered portion TP gradually increases to the outer diameter of container 11. Tapered portion TP has an upper end inserted into an outlet port 12b of inlet tube 12. With tapered portion TP having the upper end inserted into outlet port 12b of inlet tube 12, an outer circumferential surface of tapered portion TP and an inner circumferential surface IS of inlet tube 12 are welded together by weld 17a. Lower portion LP has an upper end inserted into tapered portion TP at a lower end of tapered portion TP. With lower portion LP having the upper end inserted into tapered portion TP at the lower end of tapered portion TP, an internal wall surface of tapered portion TP and an external wall surface of lower portion LP are welded together by weld 17b.

Inlet tube 12 is connected to a discharge side of compressor 1 shown in FIG. 1. Inlet tube 12 is connected to an upper end of container 11. Inlet tube 12 extends in the vertical direction along a central axis CL. Inlet tube 12 has central axis CL extending in the vertical direction. In the present embodiment, inlet tube 12 has central axis CL coaxially with the central axis of container 11. Inlet tube 12 has inner circumferential surface IS surrounding central axis CL.

Inlet tube 12 is configured to allow a gas-liquid two-phase fluid to flow into gas-liquid separation device 10. In the present embodiment, inlet tube 12 is configured to allow oil-containing refrigerant to flow into gas-liquid separation device 10. Inlet tube 12 has inlet port 12a allowing the gas-liquid two-phase fluid to flow into gas-liquid separation device 10. Inlet tube 12 has outlet port 12b allowing the gas-liquid two-phase fluid to flow out into container 11. Inlet port 12a of inlet tube 12 is disposed above swirl vane 15. Outlet port 12b of inlet tube 12 is disposed below swirl vane 15.

Liquid outlet tube 13 is connected to oil returning pipe 20 shown in FIG. 1. Liquid outlet tube 13 is connected to a lower end of container 11. Liquid outlet tube 13 is disposed at a position different from the central axis of container 11 and central axis CL of inlet tube 12. Liquid outlet tube 13 passes through the bottom of container 11. Liquid outlet tube 13 is configured to discharge from container 11 a liquid separated from the gas-liquid two-phase fluid. Liquid outlet tube 13 has a liquid outlet port 13a to discharge from container 11 the liquid separated from the gas-liquid two-phase fluid. In the present embodiment, liquid outlet tube 13 is configured to discharge from container 11 oil separated from oil-containing refrigerant. Liquid outlet port 13a of liquid outlet tube 13 is disposed below swirl vane 15.

Gas outlet tube 14 is connected to four-way valve 2 shown in FIG. 1. Gas outlet tube 14 is connected to the lower end of container 11. Gas outlet tube 14 is located coaxially with the central axis of container 11 and central axis CL of inlet tube 12. Gas outlet tube 14 passes through the bottom of container 11. Gas outlet tube 14 has a gas outlet port 14a to discharge from container 11 a gas separated from the gas-liquid two-phase fluid. In the present embodiment, gas outlet tube 14 is configured to discharge from container 11 refrigerant that is oil-containing refrigerant having oil separated therefrom. Gas outlet port 14a is disposed so as to overlap central axis CL.

Gas outlet port 14a of gas outlet tube 14 is located below swirl vane 15 and above liquid outlet port 13a. That is, gas outlet port 14a of gas outlet tube 14 is located between swirl vane 15 and liquid outlet port 13a in the vertical direction. Gas outlet port 14a is provided at a top end of gas outlet tube 14 disposed in container 11. Gas outlet port 14a is located exactly under swirl vane 15. Gas outlet port 14a is spaced from swirl vane 15 in the vertical direction with an inlet region therebetween. Gas outlet tube 14 has an outer diameter smaller than the inner diameter of container 11.

Swirl vane 15 is configured to pass the gas-liquid two-phase fluid from an upper side to a lower side while swirling the fluid. Swirl vane 15 is configured to generate a swirling stream. Swirl vane 15 is configured to cause a liquid that is separated from the gas-liquid two-phase fluid by a swirling force of the swirling stream to flow from the upper side to the lower side while causing the liquid to flow around along inner circumferential surface IS. Swirl vane 15 is disposed in inlet tube 12. Swirl vane 15 is disposed exactly under inlet port 12a of inlet tube 12.

As shown in FIGS. 2 and 3, inner circumferential surface IS of inlet tube 12 is provided with a depression DP. Depression DP faces swirl vane 15. In the present embodiment, inlet tube 12 includes a tubular portion PP and a mesh 16. Tubular portion PP has a cylindrical shape. Mesh 16 has a cylindrical shape. Mesh 16 is disposed inside tubular portion PP. Mesh 16 is disposed between swirl vane 15 and tubular portion PP. Depression DP is provided on mesh 16. Depression DP is a hole provided on mesh 16. Mesh 16 is, for example, a wire-woven mesh.

As shown in FIGS. 2 and 4, swirl vane 15 includes a main body 15a and a terminal portion 15b. As shown in FIGS. 2 and 5, main body 15a extends helically along central axis CL. Main body 15a is configured to be twisted around central axis CL with a rotation angle of 360 degrees. Swirl vane 15 may be formed by twisting a single thin plate. Main body 15a is surrounded by mesh 16. Main body 15a has an outer diameter equal to the inner diameter of mesh 16.

Terminal portion 15b is connected to a lower end of main body 15a. Terminal portion 15b includes a foot 15b1 and a projection 15b2. Foot 15b1 is connected to the lower end of main body 15a. Projection 15b2 projects toward tubular portion PP from foot 15b1 in the radial direction of inlet tube 12. Projection 15b2 has an upper end in contact with a lower end of mesh 16. Projection 15b2 positions swirl vane 15 and mesh 16.

As shown in FIGS. 4 and 5, when swirl vane 15 is viewed from the lower side toward the upper side along central axis CL, projection 15b2 has one end and the other end curved on opposite sides with respect to foot 15b1. When swirl vane 15 is viewed from the lower side toward the upper side along central axis CL, projection 15b2 has one end and the other end formed in an arc. Projection 15b2 has an outer diameter equal to the inner diameter of tubular portion PP.

A notch 15b3 is provided at a lower end of terminal portion 15b. Notch 15b3 is inclined downward from the center of the lower end of terminal portion 15b outward.

Hereinafter, an operation of refrigeration cycle apparatus 100 according to the present embodiment will be described with reference to FIG. 1 again. In the figure, an arrow of a solid line indicates flow of refrigerant in the cooling operation, and an arrow of a broken line indicates flow of refrigerant in the heating operation.

Refrigeration cycle apparatus 100 of the present embodiment can selectively perform the cooling operation and the heating operation. In the cooling operation, refrigerant circulates through the refrigerant circuit through compressor 1, gas-liquid separation device (an oil separator) 10, four-way valve 2, outdoor heat exchanger 3, flow rate regulating valve 4, and indoor heat exchanger 5 in this order. In the cooling operation, outdoor heat exchanger 3 functions as a condenser, and indoor heat exchanger 5 functions as an evaporator. In the heating operation, refrigerant circulates through the refrigerant circuit through compressor 1, gas-liquid separation device 10, four-way valve 2, indoor heat exchanger 5, flow rate regulating valve 4, and outdoor heat exchanger 3 in this order. In the heating operation, indoor heat exchanger 5 functions as a condenser, and outdoor heat exchanger 3 functions as an evaporator.

Further, the cooling operation will be described in detail. When compressor 1 is driven, compressor 1 discharges a high-temperature and high-pressure, gaseous refrigerant. The refrigerant contains oil which lubricates an interior of the compressor. That is, the refrigerant is an oil-containing refrigerant. The high-temperature and high-pressure gaseous oil-containing refrigerant discharged from compressor 1 flows into gas-liquid separation device 10. Gas-liquid separation device 10 separates oil from the oil-containing refrigerant. The refrigerant having the oil separated therefrom by gas-liquid separation device 10 flows into outdoor heat exchanger 3 via four-way valve 2. In outdoor heat exchanger 3, heat exchange is performed between the gas refrigerant flowing into outdoor heat exchanger 3 and outdoor air. Thus, the high-temperature and high-pressure gas refrigerant condenses into a high-pressure liquid refrigerant.

Outdoor heat exchanger 3 outputs the high-pressure liquid refrigerant, which is received by flow rate regulating valve 4 and therethrough becomes refrigerant in a gas-liquid two-phase state of low-pressure gas refrigerant and liquid refrigerant. The refrigerant in the gas-liquid two-phase state flows into indoor heat exchanger 5. In indoor heat exchanger 5, heat exchange is performed between the refrigerant in the gas-liquid two-phase state flowing into indoor heat exchanger 5 and indoor air. The refrigerant in the gas-liquid two-phase state thus has the liquid refrigerant evaporated and thus becomes low-pressure gas refrigerant. This heat exchange cools an interior of a room. Indoor heat exchanger 5 outputs the low-pressure gas refrigerant which in turn flows via four-way valve 2 into compressor 1 and is compressed therein into high-temperature and high-pressure gas refrigerant and thus discharged again from compressor 1. Thereafter, this cycle is repeated.

The heating operation will also be described in detail. As done in the cooling operation, when compressor 1 is driven, compressor 1 discharges a high-temperature and high-pressure, gaseous oil-containing refrigerant. The high-temperature and high-pressure gaseous oil-containing refrigerant discharged from compressor 1 flows into gas-liquid separation device 10. Gas-liquid separation device 10 separates oil from the oil-containing refrigerant. The refrigerant having the oil separated therefrom by gas-liquid separation device 10 flows into indoor heat exchanger 5 via four-way valve 2. In indoor heat exchanger 5, heat exchange is performed between the gas refrigerant flowing into indoor heat exchanger 5 and indoor air. Thus, the high-temperature and high-pressure gas refrigerant condenses into a high-pressure liquid refrigerant. This heat exchange warms an interior of a room.

Indoor heat exchanger 5 outputs the high-pressure liquid refrigerant, which is received by flow rate regulating valve 4 and therethrough becomes refrigerant in a gas-liquid two-phase state of low-pressure gas refrigerant and liquid refrigerant. The refrigerant in the gas-liquid two-phase state flows into outdoor heat exchanger 3. In outdoor heat exchanger 3, heat exchange is performed between the refrigerant in the gas-liquid two-phase state flowing into outdoor heat exchanger 3 and outdoor air. The refrigerant in the gas-liquid two-phase state thus has the liquid refrigerant evaporated and thus becomes low-pressure gas refrigerant. Outdoor heat exchanger 3 outputs the low-pressure gas refrigerant which in turn flows via four-way valve 2 into compressor 1 and is compressed thereby into high-temperature and high-pressure gas refrigerant and thus discharged again from compressor 1. Thereafter, this cycle is repeated.

Hereinafter, an operation of gas-liquid separation device (or oil separator) 10 according to the present embodiment will be described with reference to FIGS. 1 and 2 again. FIG. 2 shows a state in which a gas (refrigerant) and a liquid (oil) are separated from each other in gas-liquid separation device 10 according to the present embodiment. In FIG. 2, oil flows as indicated by a dashed arrow.

As shown in FIG. 1, in the refrigerant circuit of refrigeration cycle apparatus 100, the oil-containing refrigerant discharged from compressor 1 is separated into refrigerant and oil by gas-liquid separation device 10. The oil-containing refrigerant includes refrigerant, and oil (refrigerator oil) sealed in compressor 1. The refrigerant separated from the oil-containing refrigerant by gas-liquid separation device 10 is discharged to four-way valve 2. On the other hand, the oil separated from the oil-containing refrigerant by gas-liquid separation device 10 is discharged to a suction side of compressor 1 through oil returning pipe 20.

As shown in FIG. 2, when a gas-liquid two-phase fluid, or the oil-containing refrigerant, flows into gas-liquid separation device 10 through inlet port 12a of inlet tube 12, the oil-containing refrigerant has oil separated by a swirling stream generated by swirl vane 15. The oil separated from the oil-containing refrigerant is centrifugally moved toward inner circumferential surface IS of inlet tube 12. The oil moved to inner circumferential surface IS adheres to depression DP provided on mesh 16 of inlet tube 12. Depression DP allows inner circumferential surface IS to have an increased wet area and thus enhances oil adhesion strength on the side of inner circumferential surface IS. This suppresses swirling of the oil upward by the swirling stream.

The oil is flowed by gravity and the swirling stream along inner circumferential surface IS and thus passes through outlet port 12b into container 11, and flows along the internal wall surface of container 11 to the bottom of container 11. In this way, oil 200 is collected in container 11. Oil 200 thus collected is discharged through liquid outlet tube 13 via liquid outlet port 13a. Oil 200 discharged through liquid outlet tube 13 is returned to the suction side of compressor 1 through oil returning pipe 20 shown in FIG. 1. The refrigerant having oil 200 separated therefrom is discharged through gas outlet tube 14 via gas outlet port 14a. The refrigerant discharged through gas outlet tube 14 flows into four-way valve 2.

Hereinafter, a function and effect of the present embodiment will be described. In gas-liquid separation device 10 of the present invention, inlet tube 12 has inner circumferential surface IS provided with depression DP, and depression DP faces swirl vane 15. Depression DP can increase an area to which liquid adheres, and also prevent inlet tube 12 from having an increased size. This can improve efficiency of separating gas and liquid and also miniaturize gas-liquid separation device 10.

Swirl vane 15 generates a swirling stream which centrifugally separates oil from gas-liquid two-phase fluid, and the oil moves toward inner circumferential surface IS of inlet tube 12. While the oil adheres to inner circumferential surface IS of inlet tube 12, the oil may be swirled upward by the swirling stream if inner circumferential surface IS has small oil adhesion strength. In order to enhance the oil adhesion strength of inner circumferential surface IS of inlet tube 12, it is effective to increase a wet surface area of inner circumferential surface IS. Depression DP increases the wet surface area of inner circumferential surface IS of inlet tube 12, and can thus enhance the oil adhesion strength of inner circumferential surface IS. This can suppress upward swirling by the swirling stream of the oil adhering to inner circumferential surface IS of inlet tube 12.

Notch 15b3 provided at the lower end of terminal portion 15b of swirl vane 15 is inclined downward from the center of the lower end of terminal portion 15b outward. This allows oil adhering to the lower end of terminal portion 15b to be guided from the center of the lower end of terminal portion 15b toward inner circumferential surface IS of inlet tube 12. This can suppress dripping of oil from the center of the lower end of terminal portion 15b.

In gas-liquid separation device 10 of the present embodiment, tapered portion TP is inclined to have an inner diameter reduced toward inlet tube 12, and can thus reduce resistance and scattering of oil flowing from inner circumferential surface IS of inlet tube 12 to the internal wall surface of container 11.

With tapered portion TP having an upper end inserted into outlet port 12b of inlet tube 12, an outer circumferential surface of tapered portion TP and inner circumferential surface IS of inlet tube 12 are welded together. Thus, a structure with a practical welding and assembling method considered can be implemented.

In gas-liquid separation device 10 according to the present embodiment, depression DP is provided on mesh 16. Thus, mesh 16 can increase an area to which liquid adheres.

Mesh 16 increases a wet area of inner circumferential surface IS of inlet tube 12, and can thus enhance oil adhesion strength of inner circumferential surface IS.

An oil separator as gas-liquid separation device 10 according to the present embodiment can improve efficiency of separating oil and hence efficiency of returning oil to compressor 1. This can suppress shortage of oil and hence seizure of a sliding portion of compressor 1. Further, it can also suppress stagnation in outdoor heat exchanger 3 and indoor heat exchanger 5 of oil discharged from compressor 1. This can suppress reduction of a coefficient of performance (COP) of refrigeration cycle apparatus 100.

Refrigeration cycle apparatus 100 of the present embodiment comprises gas-liquid separation device 10, and can thus improve efficiency of separating gas and liquid and also allows gas-liquid separation device 10 to be compact. As a result, a highly efficient and compact oil separator suitable for a vapor compression refrigeration cycle of an air conditioner, a refrigerator and the like can be provided.

### Second Embodiment

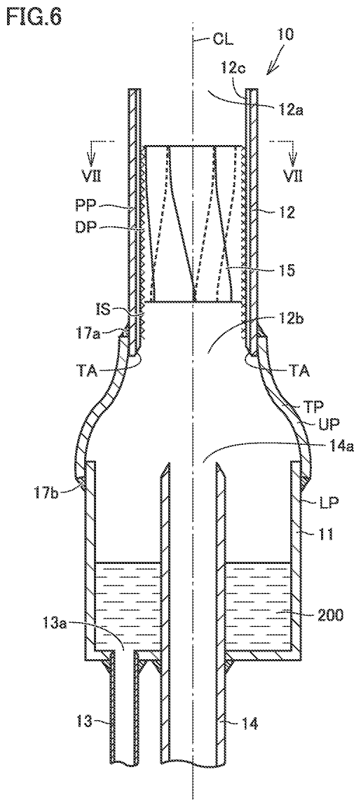

A second embodiment of the present invention will now be described with reference to FIGS. 6 to 9. The second embodiment of the present invention has the same configuration, operation, and effect as those of the first embodiment of the present invention unless otherwise specified. Therefore, any configuration identical to that of the first embodiment of the present invention is identically denoted and will not be described repeatedly.

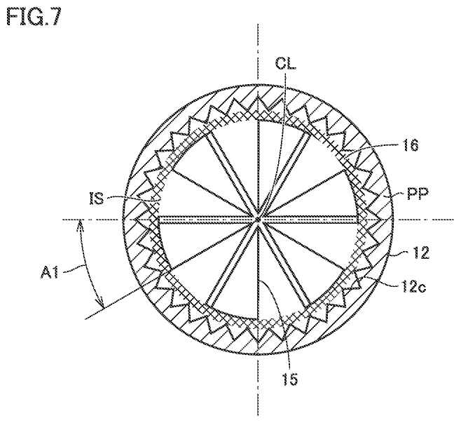

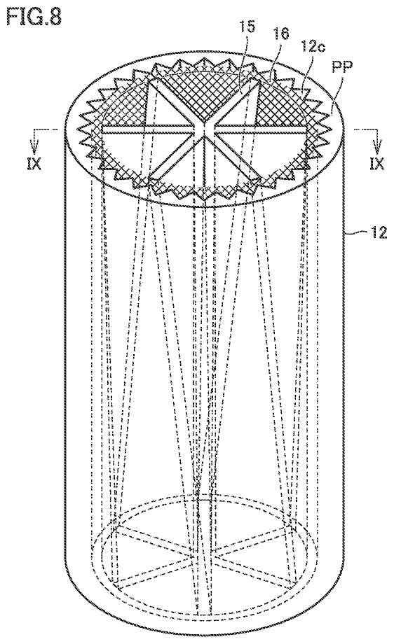

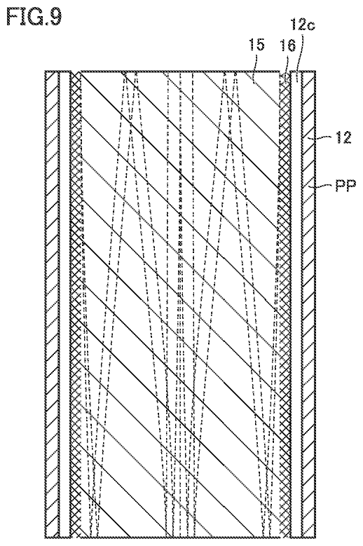

FIG. 6 is a schematic cross section of a configuration of gas-liquid separation device 10 according to the present embodiment. FIG. 7 is a cross section taken along a line VII-VII indicated in FIG. 6. FIG. 8 is a schematic perspective view of a configuration with swirl vane 15 according to the present embodiment disposed in inlet tube 12. For the sake of illustration, FIG. 8 does not show a portion of inlet tube 12 above swirl vane 15 and that of inlet tube 12 below swirl vane 15. FIG. 9 is a cross section taken along a line IX-IX indicated in FIG. 8.

As shown in FIGS. 6 and 7, in the present embodiment, depression DP is provided on mesh 16 and also includes a plurality of grooves 12c provided at tubular portion PP. Each of the plurality of grooves 12c is provided on an inner circumferential surface of tubular portion PP of inlet tube 12. Each of the plurality of grooves 12c communicates with a hole provided in mesh 16. Each of the plurality of grooves 12c extends from inlet port 12a of inlet tube 12 to outlet port 12b of inlet tube 12. Each of the plurality of grooves 12c extends linearly in the vertical direction. Mesh 16 is disposed between swirl vane 15 and tubular portion PP.

Tubular portion PP has a wall thickness for example of 1.0 mm, and each of the plurality of grooves 12c has a depth for example 0.3 mm. The plurality of grooves 12c are formed in a V-shape or a U-shape, for example. The plurality of grooves 12c are arranged at equal intervals, for example. The plurality of grooves 12c are, for example, 60 grooves 12c.

A taper TA is provided on the side of the inner circumference of the lower end of inlet tube 12. Taper TA has a dimension of C0.5, for example.

As shown in FIGS. 7 and 8, in the present embodiment, swirl vane 15 is six vanes. That is, swirl vane 15 has six vane members. A twist angle A1 of each of the six vanes of swirl vane 15 is, for example, 30 degrees.

As shown in FIGS. 8 and 9, the twist angle of each of the six vanes of swirl vane 15 is a twist angle from the upper end of swirl vane 15 to the lower end of swirl vane 15.

Hereinafter, a function and effect of the present embodiment will be described. In gas-liquid separation device 10 of the present embodiment, depression DP is provided on mesh 16 and also includes a plurality of grooves 12c provided at tubular portion PP. Mesh 16 and groove 12c can increase an area to which liquid adheres. This can further improve efficiency of separating gas and liquid.

Taper TA is provided on the side of the inner circumference of the lower end of inlet tube 12. This allows smoother connection with the internal wall surface of tapered portion TP. This can suppress upward swirling and scattering of oil from the lower end of inlet tube 12.

When swirl vane 15 that is six vanes is compared with a single vane as shown in the first embodiment, the former can have a larger surface area than the latter. This helps the liquid contained in the gas-liquid two-phase fluid to come into contact with and adhere to swirl vane 15 and can thus further improve efficiency of separating gas and liquid.

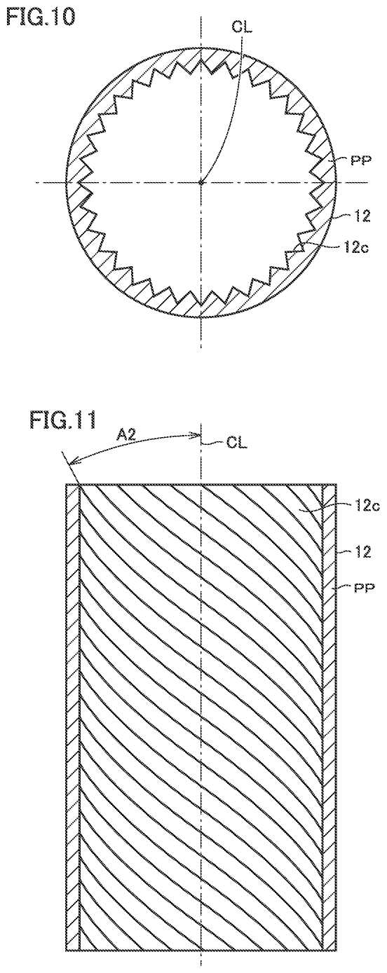

Subsequently, an exemplary variation of gas-liquid separation device 10 according to the present embodiment will be described with reference to FIGS. 10 to 13. The exemplary variation of gas-liquid separation device 10 according to the present embodiment has the same configuration, operation, and effect as gas-liquid separation device 10 of the present embodiment described above unless otherwise specified. Therefore, any configuration identical to that of gas-liquid separation device 10 of the present embodiment described above is identically denoted and will not be described repeatedly.

As shown in FIGS. 10 and 11, in a first exemplary variation of gas-liquid separation device 10 according to the present embodiment, each of the plurality of grooves 12c extends helically along central axis CL. A lead angle A2 of each of the plurality of grooves 12c in the vertical direction is, for example, 30 degrees.

In the first exemplary variation of gas-liquid separation device 10 of the present embodiment, each of the plurality of grooves 12c extends helically along central axis CL. Therefore, a grooved copper tube mass-produced can be used as tubular portion PP provided with each of the plurality of grooves 12c. This can increase an area to which liquid adheres while suppressing an increase in a processing cost.

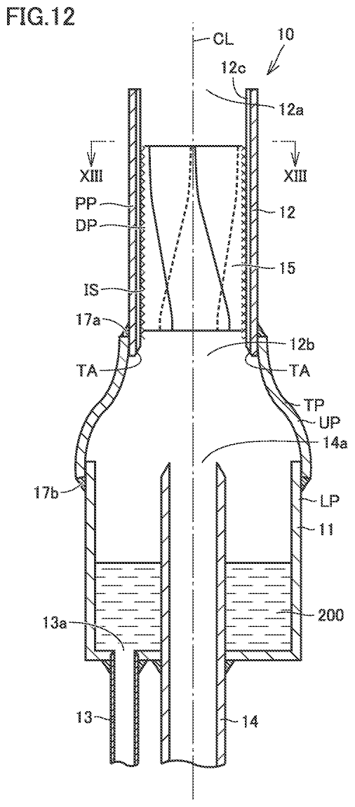

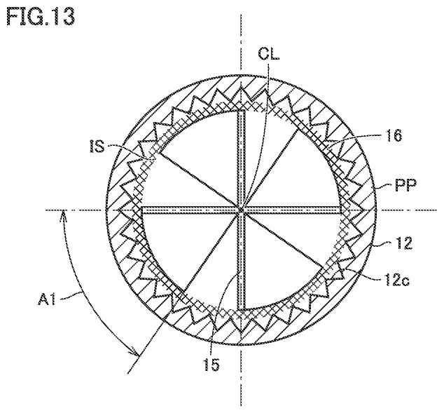

As shown in FIGS. 12 and 13, in a second exemplary variation of gas-liquid separation device 10 according to the present embodiment, swirl vane 15 is four vanes. Twist angle A1 of each of the four vanes of swirl vane 15 is 60 degrees, for example.

In the second exemplary variation of gas-liquid separation device 10 of the present embodiment, swirl vane 15 is four vanes, and when it is compared with a single vane as shown in the first embodiment, the former can have a larger surface area than the latter. This helps the liquid contained in the gas-liquid two-phase fluid to come into contact with and adhere to swirl vane 15 and can thus further improve efficiency of separating gas and liquid.

### Third Embodiment

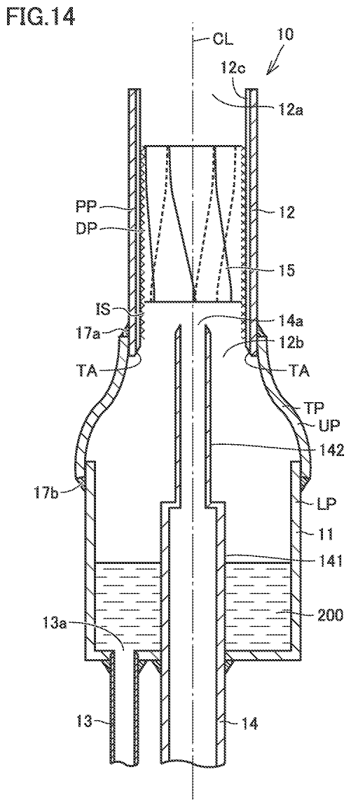

A third embodiment of the present invention will now be described with reference to FIG. 14. The third embodiment of the present invention has the same configuration, operation, and effect as those of the second embodiment of the present invention unless otherwise specified. Therefore, any configuration identical to that of the second embodiment of the present invention is identically denoted and will not be described repeatedly.

FIG. 14 is a schematic cross section of a configuration of gas-liquid separation device 10 according to the present embodiment. As shown in FIG. 14, in the present embodiment, gas outlet port 14a of gas outlet tube 14 is inserted into outlet port 12b of inlet tube 12. Gas outlet port 14a of gas outlet tube 14 is higher in level than outlet port 12b of inlet tube 12.

Gas outlet tube 14 includes a radially larger portion 141 and a radially smaller portion 142. Radially larger portion 141 is located under radially smaller portion 142. Radially smaller portion 142 is smaller in diameter than radially larger portion 141. Radially smaller portion 142 is inserted into outlet port 12b of inlet tube 12.

In gas-liquid separation device 10 of the present embodiment, gas outlet port 14a of gas outlet tube 14 is inserted into outlet port 12b of inlet tube 12. This can suppress inflow into gas outlet port 14a of oil swirled upward from the lower end of inlet tube 12.

Radially smaller portion 142 of gas outlet tube 14 is inserted into outlet port 12b of inlet tube 12. This allows pressure loss of inlet tube 12 to be reduced by radially smaller portion 142. Further, since gas outlet port 14a is provided at radially smaller portion 142, inflow of oil into gas outlet port 14a can be suppressed.

### Fourth Embodiment

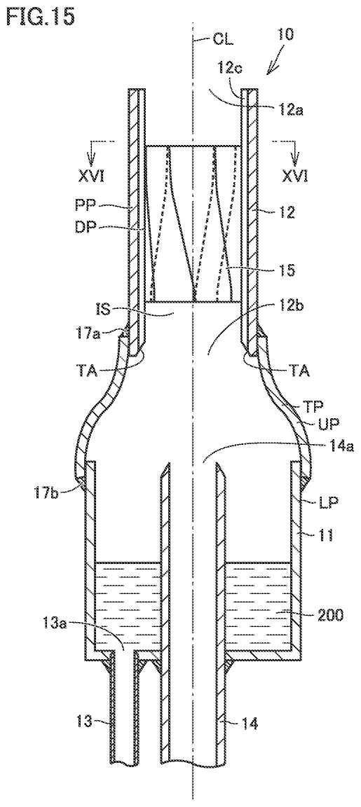

A fourth embodiment of the present invention will now be described with reference to FIGS. 15 to 18. The fourth embodiment of the present invention has the same configuration, operation, and effect as those of the second embodiment of the present invention unless otherwise specified. Therefore, any configuration identical to that of the second embodiment of the present invention is identically denoted and will not be described repeatedly.

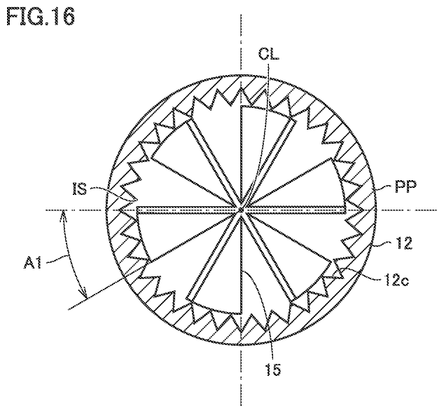

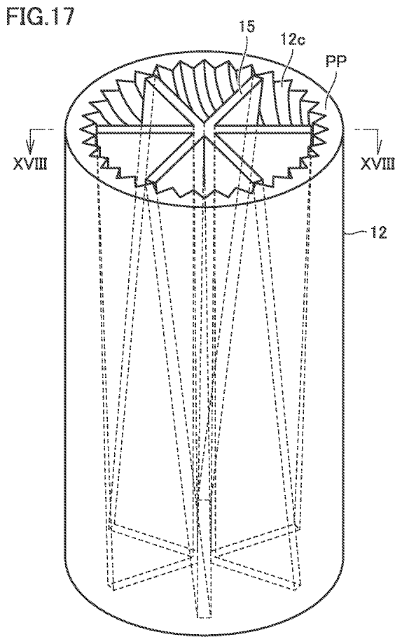

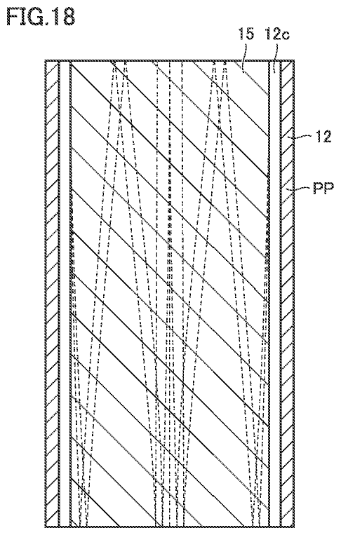

FIG. 15 is a schematic cross section of a configuration of gas-liquid separation device 10 according to the present embodiment. FIG. 16 is a cross section taken along a line XVI-XVI indicated in FIG. 15. FIG. 17 is a schematic perspective view of a configuration with swirl vane 15 according to the present embodiment disposed in inlet tube 12. For the sake of illustration, FIG. 17 does not show a portion of inlet tube 12 above swirl vane 15 and that of inlet tube 12 below swirl vane 15. FIG. 18 is a cross section taken along a line XVIII-XVIII indicated in FIG. 17.

As shown in FIGS. 15 and 16, in the present embodiment, inlet tube 12 is composed of tubular portion PP and does not include mesh 16. Depression DP includes a plurality of grooves 12c. The plurality of grooves 12c are provided at tubular portion PP. Each of the plurality of grooves 12c extends from inlet port 12a of inlet tube 12 to outlet port 12b of inlet tube 12. Each of the plurality of grooves 12c extends helically along central axis CL. Lead angle A2 of each of the plurality of grooves 12c in the vertical direction is, for example, 30 degrees.

Swirl vane 15 extends helically along central axis CL. Lead angle A2 of each of the plurality of grooves 12c in the vertical direction is twisted in a direction aligned with the twist angle of swirl vane 15. Lead angle A2 of each of the plurality of grooves 12c in the vertical direction (see FIG. 11) matches the twist angle of swirl vane 15. Swirl vane 15 has an outer peripheral end in contact with inner circumferential surface IS of inlet tube 12.

In gas-liquid separation device 10 of the present embodiment, lead angle A2 of each of the plurality of grooves 12c in the vertical direction matches the twist angle of swirl vane 15. This facilitates inserting swirl vane 15 into inlet tube 12. It also facilitates fixing swirl vane 15 to inlet tube 12.

The above embodiments can be combined as appropriate.

It should be understood that the embodiments disclosed herein have been described for the purpose of illustration only and in a non-restrictive manner in any respect. The scope of the present invention is defined by the terms of the claims, rather than the description above, and is intended to include any modifications within the meaning and scope equivalent to the terms of the claims.

1. A gas-liquid separation device configured to separate a gas-liquid two-phase fluid into gas and liquid, the gas-liquid separation device comprising:
a container extending in a top-to-bottom direction;
an inlet tube extending along a central axis in the top-to-bottom direction and having an inner surface surrounding the central axis, an inlet port configured to allow the gas-liquid two-phase fluid to flow into the gas-liquid separation device, and an outlet port configured to allow the gas-liquid two-phase fluid to flow into the container;
a liquid outlet tube having a liquid outlet port configured to allow the liquid separated from the gas-liquid two-phase fluid to be discharged from the container;
a gas outlet tube having a gas outlet port configured to allow the gas separated from the gas-liquid two-phase fluid to be discharged from the container; and
a swirl vane located in the inlet tube,
the inlet port of the inlet tube being located above the swirl vane,
the outlet port of the inlet tube being located below the swirl vane,
the liquid outlet port of the liquid outlet tube being located below the swirl vane,
the gas outlet port of the gas outlet tube being located below the swirl vane and above the liquid outlet port,
the inner surface of the inlet tube having a depression,
the depression facing the swirl vane, wherein
the inlet tube comprises a tubular portion and a mesh,
the depression is provided on the mesh and comprises a plurality of grooves provided at the tubular portion,
each of the plurality of grooves extends from the inlet port of the inlet tube to the outlet port of the inlet tube, and
the mesh is disposed between the swirl vane and the tubular portion.

2. The gas-liquid separation device according to claim 1, wherein
the container comprises a tapered portion connected to the inlet tube, and
the tapered portion is inclined to have a smaller inner diameter toward the inlet tube.

3. The gas-liquid separation device according to claim 1, wherein
the depression is provided on the mesh.

4. The gas-liquid separation device according to claim 1, wherein
each of the plurality of grooves extends from the inlet port of the inlet tube to the outlet port of the inlet tube.

5. (canceled)

6. The gas-liquid separation device according to claim 1, wherein each of the plurality of grooves extends helically along the central axis.

7. The gas-liquid separation device according to claim 6, wherein
the swirl vane extends helically along the central axis, and
a lead angle of each of the plurality of grooves in the top-to-bottom direction matches a twist angle of the swirl vane.

8. The gas-liquid separation device according to claim 1, wherein the gas outlet port of the gas outlet tube is inserted into the outlet port of the inlet tube.

9. A refrigeration cycle apparatus comprising the gas-liquid separation device according to claim 1.
